(19) United States
(12) Patent Application Publication
(10) Pub. No.: US 2016/0353381 A1
(43) Pub. Date: Dec. 1, 2016

(54) OPERATIONAL MANAGEMENT METHODS AND SYSTEMS FOR A WIRELESS CONNECTING UNIT

(71) Applicant: Noodoe Corporation, Taipei City (TW)

(72) Inventors: Chi-Hui Hsu, Taipei City (TW); John C. Wang, Taipei City (TW)

(21) Appl. No.: 15/137,109

(22) Filed: Apr. 25, 2016

(30) Foreign Application Priority Data
May 29, 2015 (TW) 104117402

(51) Int. Cl. H04W 52/02; H04W 4/02

(52) U.S. Cl. CPC H04W 52/0251; H04W 4/027

(57) ABSTRACT

Operational management methods and systems for a wireless connecting unit are provided. Motion information corresponding to an electronic device is detected by at least one motion sensor of the electronic device, and it is determined whether the electronic device is motionless or substantially motionless according to the motion information. When the motion information indicates that the electronic device is motionless or substantially motionless, the wireless connecting unit is instructed to enter a power-saving state.

### BACKGROUND OF THE INVENTION

Field of the Invention

The disclosure relates generally to operational management methods and systems for a wireless connecting unit, and, more particularly to methods and systems that can determine the operation of a wireless connecting unit according to the movement of an electronic device.

Description of the Related Art

Recently, electronic devices, such as smart phones, tablets, notebooks, and other portable devices, have become more and more technically advanced and multifunctional. For example, portable devices have network connectivity capabilities. Users can use their portable devices to connect to networks at anytime and anywhere. The convenience and new functionalities advanced by modern technology have made these devices into necessities of life.

On the other hand, with the coming of IOT (Internet Of Things) generation, every device or object can connect to networks, and users can access and control these devices or objects via networks. Currently, wearable electronic devices have become the most tangible applications of IOT. In some cases, the wearable device can detect health information of a user, record exercise information and sleep patterns, display email messages, or incoming call notifications.

One shortcoming of wearable devices is their battery capacity due to the physical size restrictions of the devices. This has elevated the importance of battery life and power management in the IOT field. In some cases of network communication, a smart phone can transmit related notifications, such as email messages or incoming calls to the wearable electronic device via a wireless network. Since any communication between the smart phone and the wearable electronic device consumes power of the wearable electronic device, the power usage efficiency of the wearable electronic device can be improved if the communications between the smart phone and the wearable electronic device are appropriately managed. In some cases, the transmission of information between the smart phone and the wearable electronic device may be unnecessary. For example, when a user does not currently wear a wearable electronic device, the process of transmitting related notifications to the wearable electronic device may be redundant. Furthermore, the increased power consumption of the wearable electronic device is also wasted.

### BRIEF SUMMARY OF THE INVENTION

Operational management methods and systems for a wireless connecting unit are provided, wherein the operation of a wireless connecting unit can be determined according to the movement of an electronic device, such as a wearable electronic device.

In an embodiment of an operational management method for a wireless connecting unit, motion information corresponding to an electronic device is detected by at least one motion sensor of the electronic device, and it is determined whether the electronic device is motionless or substantially motionless according to the motion information. When the motion information indicates that the electronic device is motionless or substantially motionless, the wireless connecting unit is instructed to enter a power-saving state.

An embodiment of an operational management system for a wireless connecting unit comprises at least one motion sensor, a wireless connecting unit, and a controller. The motion sensor detects motion information corresponding to an electronic device. The controller determines whether the electronic device is motionless or substantially motionless according to the motion information. When the motion information indicates that the electronic device is motionless or substantially motionless, the controller instructs the wireless connecting unit to enter a power-saving state.

In some embodiments, it is determined whether the electronic device is motionless or substantially motionless in a predefined interval. When the electronic device is motionless or substantially motionless in the predefined interval, the wireless connecting unit is instructed to enter the power-saving state.

In some embodiments, the motion information generated by the motion sensor at two time points within the predefined interval is obtained. When the motion information at the two time points indicates that the electronic device is motionless or substantially motionless at both of the two time points, it is determined that the electronic device is motionless or substantially motionless in the predefined interval.

In some embodiments, after the wireless connecting unit has entered the power-saving state, the motion sensor of the electronic device further detects motion information of the electronic device. When the motion information indicates that the electronic device is not motionless or substantially motionless, the wireless connecting unit is instructed to exit the power-saving state.

In some embodiments, when the wireless connecting unit has entered the power-saving state, the wireless connecting unit is powered off/turned off.

In some embodiments, when the wireless connecting unit has exited the power-saving state, the wireless connecting unit is powered on/turned on.

Operational management methods for a wireless connecting unit may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an operational management system for a wireless connecting unit of the invention;

FIG. 2 is a schematic diagram illustrating an example of a wireless connection between an electronic device and a specific electronic device of the invention;

FIG. 3 is a flowchart of an embodiment of an operational management method for a wireless connecting unit of the invention;

FIG. 4 is a flowchart of an embodiment of a method for determining whether an electronic device is motionless or substantially motionless in a predefined interval of the invention; and

FIG. 5 is a flowchart of another embodiment of an operational management method for a wireless connecting unit of the invention.

### DETAILED DESCRIPTION OF THE INVENTION

Operational management methods and systems for a wireless connecting unit are provided.

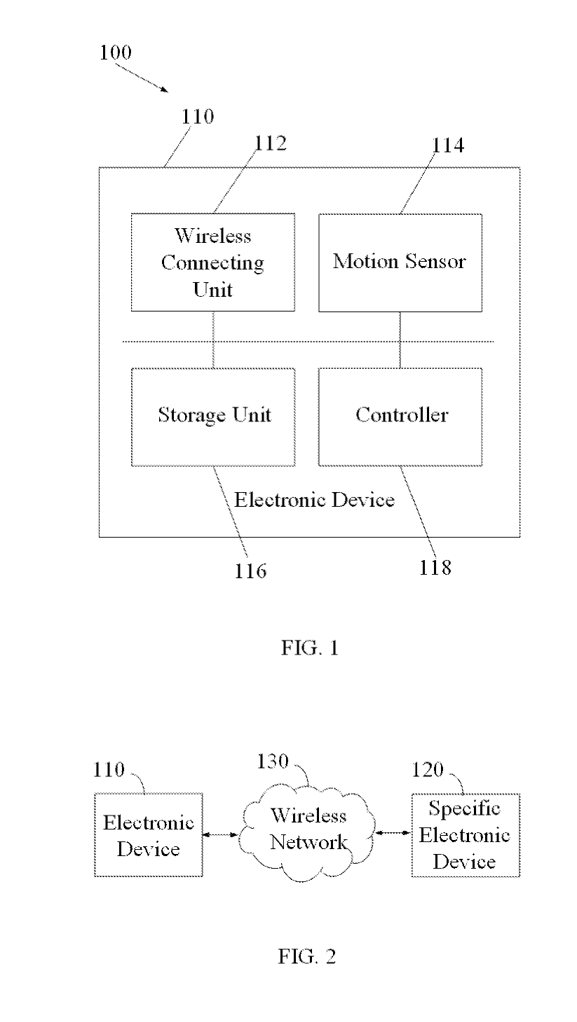

FIG. 1 is a schematic diagram illustrating an embodiment of an operational management system for a wireless connecting unit of the invention. The operational management system for a wireless connecting unit 100 can be used in an electronic device 110 having wireless connecting capabilities, such as a wearable electronic device, a mobile phone, a smart phone, a PDA (Personal Digital Assistant), a GPS (Global Positioning System), a notebook, a tablet computer, or other portable device. As shown in FIG. 1, the electronic device 110 comprises a wireless connecting unit 112, at least one motion sensor 114, a storage unit 116, and a controller 118. The wireless connecting unit 112 can connect to other electronic devices having wireless connecting capabilities via a wireless network, such as Wi-Fi or Bluetooth network. It is understood that, in some embodiments, the wireless connecting unit 112 may be a wireless connecting unit implemented with a low-power consumption technology, such as Bluetooth Smart technology. The Bluetooth Smart technology supports two modes: central and peripheral. In the central mode, the wireless connecting unit can receive data from the wireless connecting units of other electronic devices, and can actively connect to other electronic devices. In the peripheral mode, the wireless connecting unit can broadcast signals, such as its identification data. However, the wireless connecting unit cannot actively connect to other electronic devices in the peripheral mode. In other words, in some embodiments, the wireless connecting unit 112 can connect to other electronic devices having wireless connecting capabilities via a BLE (Bluetooth Low Energy) network. For example, the electronic device 110 can connect to a specific electronic device 120 via a wireless network 130, such as Wi-Fi or Bluetooth network such as BLE network, as shown in FIG. 2. In some embodiments, the electronic device 110 may be a wearable electronic device, such as a sports band or a smart watch worn on the wrist of a user. In some embodiments, the specific electronic device 120 may be any electronic device having wireless connecting capabilities, such as a mobile phone, a smart phone, a PDA, a GPS, a notebook, a tablet computer, or other portable device.

The motion sensor 114 can detect motion information corresponding to the electronic device 110. It is understood that, in some embodiments, the motion sensor 114 may be an accelerometer such as a G-sensor for generating information of velocity and displacement when the device moves. In some embodiments, the motion sensor 114 may be a Gyro sensor for generating information of angular acceleration when the device moves. It is noted that, the above motion sensors are only examples of the present application, and the present invention is not limited thereto. Any motion sensor which can detect the motion information of an electronic device can be applied in the present invention. The storage unit 116 can store related data, such as the motion information corresponding to the electronic device 110, which is generated by the motion sensor 114. The controller 118 can control related operations of hardware and software in the electronic device 110, and perform the operational management method for a wireless connecting unit of the invention. This will be discussed further in the following paragraphs.

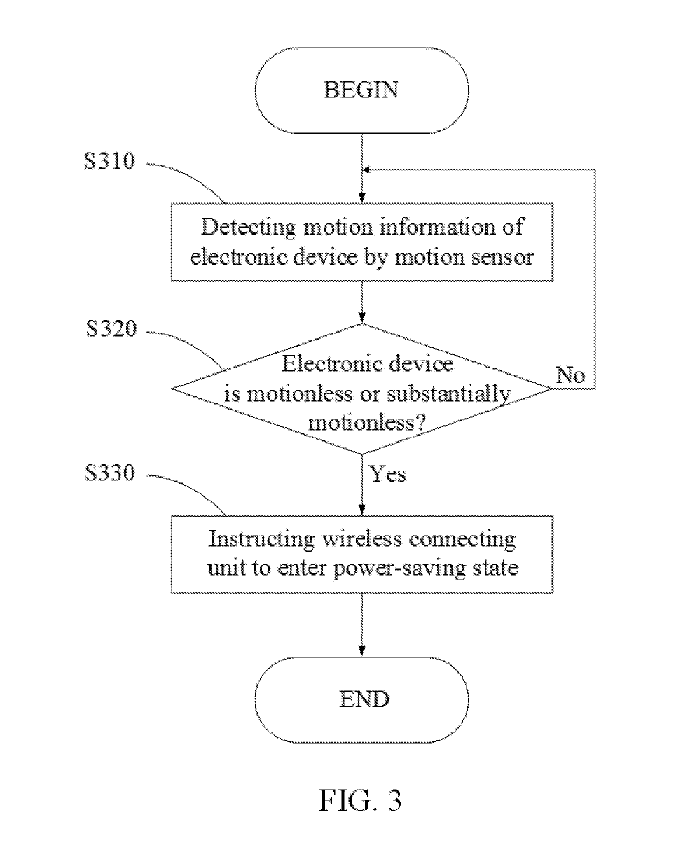

FIG. 3 is a flowchart of an embodiment of an operational management method for a wireless connecting unit of the invention. The operational management method for a wireless connecting unit can be used in an electronic device, such as a wearable electronic device, a mobile phone, a smart phone, a PDA, a GPS, a notebook, a tablet computer, or other portable device.

In step S310, motion information corresponding to the electronic device is detected by at least one motion sensor of the electronic device. It is understood that, in some embodiments, the motion sensor 114 may be an accelerometer such as a G-sensor for generating information of velocity and displacement when the device moves. In some embodiments, the motion sensor 114 may be a Gyro sensor for generating information of angular acceleration when the device moves. It is noted that, the above motion sensors are only examples of the present application, and the present invention is not limited thereto. Any motion sensor which can detect the motion information of an electronic device can be applied in the present invention. In step S320, it is determined whether the electronic device is motionless or substantially motionless according to the motion information generated by the motion sensor. When the electronic device is not motionless or substantially motionless (No in step S320), the procedure returns to step S310. When the electronic device is motionless or substantially motionless (Yes in step S320), in step S330, a wireless connecting unit of the electronic device is instructed to enter a power-saving state. It is understood that, in some embodiments, the wireless connecting unit includes at least a first operation state and a second operation state, and the power consumption in the second operation state is less than that in the first operation state. In some embodiments, when the wireless connecting unit has entered the power-saving state, the operation state of the wireless connecting unit is switched from the first operation state to the second operation state. Additionally, in some embodiments, when the wireless connecting unit has entered the power-saving state, the wireless connecting unit is powered off/turned off.

It is understood that, in some embodiments, it is determined whether the electronic device is motionless or substantially motionless in a predefined interval. When the electronic device is motionless or substantially motionless in the predefined interval, the wireless connecting unit is instructed to enter the power-saving state.

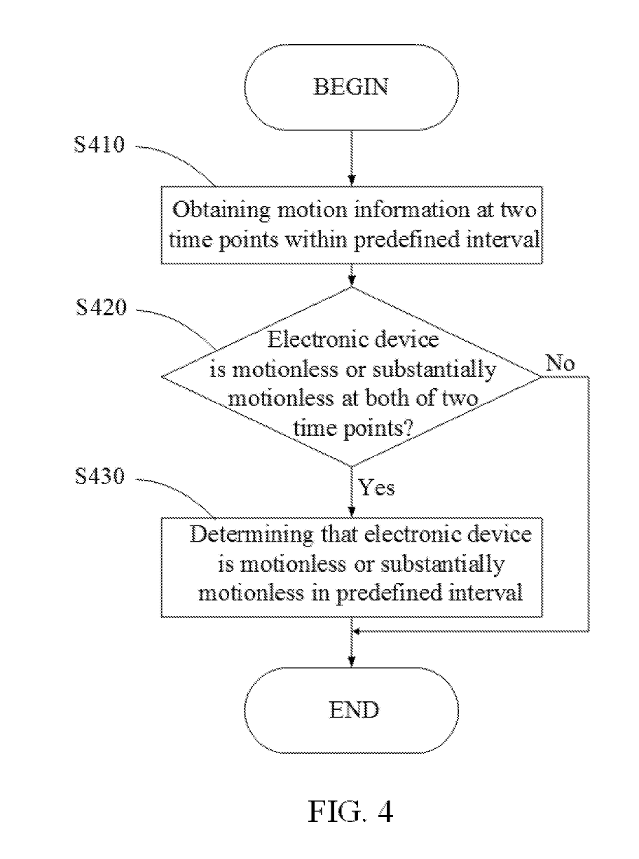

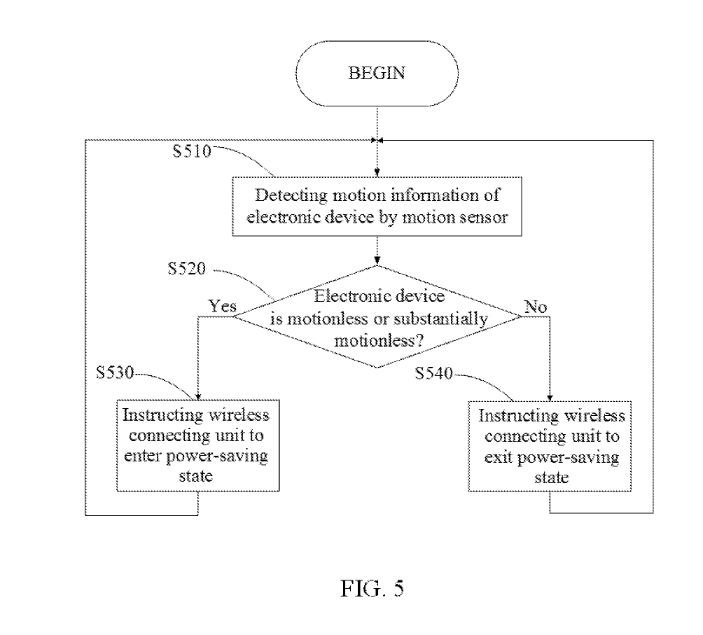

FIG. 4 is a flowchart of an embodiment of a method for determining whether an electronic device is motionless or substantially motionless in a predefined interval of the invention. In step S410, the motion information generated by the motion sensor at two time points within a predefined interval is obtained, and in step S420, it is determined whether the electronic device is motionless or substantially motionless at both of the two time points according to the motion information at the two time points. When the motion information at the two time points does not represent that the electronic device is motionless or substantially motionless at both of the two time points (No in step S420), the procedure is completed. When the motion information at the two time points indicates that the electronic device is motionless or substantially motionless at both of the two time points (Yes in step S420), in step S430, it is determined that the electronic device is motionless or substantially motionless in the predefined interval.

FIG. 5 is a flowchart of another embodiment of an operational management method for a wireless connecting unit of the invention. The operational management method for a wireless connecting unit can be used in an electronic device, such as a wearable electronic device, a mobile phone, a smart phone, a PDA, a GPS, a notebook, a tablet computer, or other portable device.

In step S510, motion information corresponding to the electronic device is detected by at least one motion sensor of the electronic device. Similarly, in some embodiments, the motion sensor 114 may be an accelerometer such as a G-sensor for generating information of velocity and displacement when the device moves. In some embodiments, the motion sensor 114 may be a Gyro sensor for generating information of angular acceleration when the device moves. It is noted that, the above motion sensors are only examples of the present application, and the present invention is not limited thereto. Any motion sensor which can detect the motion information of an electronic device can be applied in the present invention. In step S520, it is determined whether the electronic device is motionless or substantially motionless according to the motion information generated by the motion sensor. When the electronic device is motionless or substantially motionless (Yes in step S520), in step S530, a wireless connecting unit of the electronic device is instructed to enter a power-saving state. Similarly, in some embodiments, it is determined whether the electronic device is motionless or substantially motionless in a predefined interval. When the electronic device is motionless or substantially motionless in the predefined interval, the wireless connecting unit is instructed to enter the power-saving state. Similarly, in some embodiments, the wireless connecting unit includes at least a first operation state and a second operation state, and the power consumption in the second operation state is less than that in the first operation state. In some embodiments, when the wireless connecting unit has entered the power-saving state, the operation state of the wireless connecting unit is switched from the first operation state to the second operation state. Additionally, in some embodiments, when the wireless connecting unit has entered the power-saving state, the wireless connecting unit is powered off/turned off. When the electronic device is not motionless or substantially motionless (No in step S520), in step S540, the wireless connecting unit is instructed to exit the power-saving state. As described, in some embodiments, the wireless connecting unit includes at least a first operation state and a second operation state, and the power consumption in the second operation state is less than that in the first operation state. In some embodiments, when the wireless connecting unit has exited the power-saving state, the operation state of the wireless connecting unit is switched from the second operation state to the first operation state. Additionally, in some embodiments, when the wireless connecting unit has exited the power-saving state, the wireless connecting unit is powered on/turned on. It is understood that, in some embodiments, it is determined whether the wireless connecting unit is currently in the power-saving state. When the wireless connecting unit is currently in the power-saving state, step S540 is performed.

For example, when a user takes off a wearable electronic device from their wrist when going to sleep, since the wearable electronic device is motionless or substantially motionless, a wireless connecting unit of the wearable electronic device will enter a power-saving state. For example, the wireless connecting unit will be powered off. Since the power consumption for the wireless connecting unit at the power-saving state is reduced, the standby time for the wearable electronic device will be significantly extended.

Therefore, the operational management methods and systems for a wireless connecting unit of the present invention can determine the operation of a wireless connecting unit according to the movement of an electronic device, thereby improving power management for electronic devices.

Operational management methods for a wireless connecting unit may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. An operational management method for a wireless connecting unit for use in an electronic device, comprising:
detecting motion information corresponding to the electronic device by at least one motion sensor of the electronic device;
determining whether the electronic device is motionless or substantially motionless according to the motion information; and
instructing the wireless connecting unit to enter a power-saving state when the motion information indicates that the electronic device is motionless or substantially motionless.

2. The method of claim 1, further comprising:
determining whether the electronic device is motionless or substantially motionless in a predefined interval; and
instructing the wireless connecting unit to enter the power-saving state when the electronic device is motionless or substantially motionless in the predefined interval.

3. The method of claim 2, further comprising:
obtaining motion information generated by the motion sensor at two time points within the predefined interval; and
determining that the electronic device is motionless or substantially motionless in the predefined interval when the motion information at the two time points indicates that the electronic device is motionless or substantially motionless at both of the two time points.

4. The method of claim 1, wherein after the electronic device has entered the power-saving state, the method further comprises the steps of:
detecting motion information of the electronic device by the motion sensor of the electronic device; and
instructing the wireless connecting unit to exit the power-saving state when the motion information indicates that the electronic device is not motionless or substantially motionless.

5. The method of claim 1, wherein the wireless connecting unit is powered off when the wireless connecting unit has entered the power-saving state.

6. An operational management system for a wireless connecting unit for use in an electronic device, comprising:
at least one motion sensor detecting motion information corresponding to the electronic device;
a wireless connecting unit; and
a controller determining whether the electronic device is motionless or substantially motionless according to the motion information, and instructing the wireless connecting unit to enter a power-saving state when the motion information indicates that the electronic device is motionless or substantially motionless.

7. The system of claim 6, wherein the controller further determines whether the electronic device is motionless or substantially motionless in a predefined interval, and instructs the wireless connecting unit to enter the power-saving state when the electronic device is motionless or substantially motionless in the predefined interval.

8. The system of claim 7, wherein the controller further obtains motion information generated by the motion sensor at two time points within the predefined interval, and determines that the electronic device is motionless or substantially motionless in the predefined interval when the motion information at the two time points indicates that the electronic device is motionless or substantially motionless at both of the two time points.

9. The system of claim 6, wherein after the electronic device has entered the power-saving state, the motion sensor of the electronic device further detects motion information of the electronic device, and the controller instructs the wireless connecting unit to exit the power-saving state when the motion information indicates that the electronic device is not motionless or substantially motionless.

10. The system of claim 6, wherein the wireless connecting unit is powered off when the wireless connecting unit has entered the power-saving state.

11. The system of claim 9, wherein the wireless connecting unit is powered on when the wireless connecting unit has exited the power-saving state.

12. A machine-readable storage medium comprising a computer program, which, when executed, causes a device to perform an operational management method for a wireless connecting unit, wherein the method comprises:
detecting motion information corresponding to the electronic device by at least one motion sensor of the electronic device;
determining whether the electronic device is motionless or substantially motionless according to the motion information; and
instructing the wireless connecting unit to enter a power-saving state when the motion information indicates that the electronic device is motionless or substantially motionless.
